(19) United States
(12) Patent Application Publication
(10) Pub. No.: US 2018/0084420 A1
(43) Pub. Date: Mar. 22, 2018

(54) METHOD AND DEVICE FOR SWITCHING USER MODE OF INTELLIGENT TERMINAL, AND INTELLIGENT TERMINAL

(71) Applicant: Beijing Qihoo Technology Company Limited, Xicheng District (CN)

(72) Inventors: Jihuang Fan, Beijing (CN); Dewei Sun, Beijing (CN); Mingchang Shi, Beijing (CN)

(73) Assignee: Beijing Qihoo Technology Company Limited, Xicheng District (CN)

(21) Appl. No.: 15/559,135

(22) PCT Filed: Apr. 16, 2015
(86) PCT No.: PCT/CN2015/076764

§ 371 Date: Sep. 18, 2017

(30) Foreign Application Priority Data
Mar. 18, 2015 (CN) 201510119248.4

(51) Int. Cl. H04W 12/06; H04L 29/06

(52) U.S. Cl. CPC H04W 12/06; H04M 1/72577; H04L 63/083

(57) ABSTRACT

The disclosure discloses a method and device for switching a user mode of an intelligent terminal, and an intelligent terminal, the method comprises: adding a user mode switch control to a folder display interface of the intelligent terminal; displaying a lock password input interface when a user opens any folder in the intelligent terminal and triggers the user mode switch control in the normal mode; storing an input lock password, and switching to the locked mode, after the user inputs the lock password in the lock password input interface; displaying an unlock password input interface when the user triggers a mode unlock button in the locked mode; and determining whether an input unlock password is the same as the stored lock password, and if the same, then exiting the locked mode and returning to the normal mode; otherwise, remaining in the locked mode.

### CROSS-REFERENCE TO RELATED APPLICATION

This application is a U.S. National-Stage entry under 35 U.S.C. § 371 based on International Application No. PCT/CN2015/076764, filed Apr. 16, 2015, which was published under PCT Article 21(2) and which claims priority to Chinese Patent Application No. 201510119248.4, filed Mar. 18, 2015, which are all hereby incorporated in their entirety by reference.

### TECHNICAL FIELD

This Application pertains to the field of computer technologies and particularly to a method and device for switching a user mode of an intelligent terminal, and an intelligent terminal.

### BACKGROUND

Cell phones, PADs and other intelligent terminals have been significantly popularized in the life of people. People can work, communicate (including phone calls, short messages, instant communication, emails, etc.), entertain, photograph, search and conduct other activities on the intelligent terminals, so the intelligent terminals and particularly the cell phones have become necessary equipments in the life and working of people.

In real life, it is frequently necessary to have an intelligent terminal (e.g., a cell phone or a PAD) accessible to a child or lent to another person for operation. At this time the child may not be expected to operate some important file, e.g., an email in an email box, an address book, etc, and if the intelligent terminal is lent to another person for operation or display, then private contents in the intelligent terminal may not be expected to be viewed. Unfortunately, there has been absent so far a solution to this problem. In addition, other objects, desirable features and characteristics will become apparent from the subsequent summary and detailed description, and the appended claims, taken in conjunction with the accompanying drawings and this background.

### SUMMARY

In view of the problem above, the disclosure has been made to provide a method and device for switching a user mode of an intelligent terminal, and an intelligent terminal for overcoming or at least partly solving the problem above.

According to an aspect of this Application, there is provided a method for switching a user mode of an intelligent terminal, wherein the user mode comprises a normal mode and a locked mode, the method comprises:

adding a user mode switch control to a folder display interface of the intelligent terminal;

displaying a lock password input interface when a user opens any folder in the intelligent terminal and triggers the user mode switch control in the normal mode;

storing an input lock password, and switching to the locked mode, after the user inputs the lock password in the lock password input interface;

limiting the user to only an access to contents in the folder in the locked mode;

displaying an unlock password input interface when the user triggers a mode unlock button in the locked mode; and

determining whether an input unlock password is the same as the stored lock password, after the user inputs the unlock password in the unlock password input interface, and if the same, then exiting the locked mode and returning to the normal mode; otherwise, remaining in the locked mode.

According to another aspect of this Application, there is provided a device for switching a user mode of an intelligent terminal, wherein the user mode comprises a normal mode and a locked mode, the device comprises:

a control adding unit, configured to add a user mode switch control to a folder display interface of the intelligent terminal;

a mode switch responding unit, configured to display a lock password input interface when a user opens any folder in the intelligent terminal and triggers the user mode switch control in the normal mode; and to store an input lock password and to transmit an notification of switching to the locked mode to a locked mode unit, after the user inputs the lock password in the lock password input interface; and

the locked mode unit, configured to limit the user to only an access to contents in the folder in the locked mode after reception of the notification of switching to the locked mode; and to release the limit after reception of a notification of exiting the locked mode; wherein

the mode switch responding unit is further configured to display an unlock password input interface when the user triggers a mode unlock button in the locked mode; and to determine whether an input unlock password is the same as the stored lock password, after the user inputs the unlock password in the unlock password input interface, and if the same, to transmit the notification of exiting the locked mode to the locked mode unit so as to make the intelligent terminal return to the normal mode; otherwise, not to notify the locked mode unit.

According to still another aspect of this Application, there is provided an intelligent terminal including the device above for switching a user mode of an intelligent terminal.

According to still another aspect of this Application, there is provided a computer program including computer readable codes which, upon being executed on a terminal, cause the terminal to perform the method above.

According to a further aspect of this Application, there is provided a computer readable medium with the computer program above stored thereon.

As can be apparent from the embodiments above, advantageous effects of this Application over the prior art are as follows:

With the technical solution of this Application, the user can switch the intelligent terminal to the locked mode while having the intelligent terminal lent to a child or another person for use so that the child or the other person can only operate on applications in a specified folder to thereby avoid an improper operation, or the leak of private contents; and with the technical solution of this Application, it is simple in operation for the user to switch the mode with a good user experience.

Only the summary of the technical solution of this Application has been described above, and particular embodiments of this Application will be described below in order to enable the technical solution of this Application to become more apparent and to be put into practice in light of this Application of the description, and in order to make the foregoing and other objects, features and advantages of this Application more apparent.

### BRIEF DESCRIPTION OF DRAWINGS

The present invention will hereinafter be described in conjunction with the following drawing figures, wherein like numerals denote like elements, and:

FIG. 1 illustrates a flow chart of a method for switching a user mode of an intelligent terminal according to an exemplary embodiment of this Application;

FIG. 2A illustrates a schematic diagram of a folder display interface arranged with a user mode switch control according to an exemplary embodiment of this Application;

FIG. 2B illustrates a schematic diagram when the user mode switch control illustrated in FIG. 2A is triggered according to an exemplary embodiment of this Application;

FIG. 2C illustrates a schematic diagram of a lock password input interface according to an exemplary embodiment of this Application;

FIG. 2D illustrates a schematic diagram of a password being input in the lock password input interface according to an exemplary embodiment of this Application;

FIG. 2E illustrates a schematic diagram of remaining the interface on which the password is input according to an exemplary embodiment of this Application;

FIG. 2F illustrates a schematic diagram of an interface where the locked mode is entered according to an exemplary embodiment of this Application;

FIG. 2G illustrates a schematic diagram of an unlock password input interface according to an exemplary embodiment of this Application;

FIG. 2H illustrates a schematic diagram of an unlock password being input in the unlock password input interface and a resulting success in unlocking according to an exemplary embodiment of this Application;

FIG. 2I illustrates a schematic diagram of entering the normal mode after the success in unlocking according to an exemplary embodiment of this Application;

FIG. 3 illustrates a structural diagram of a device for switching a user mode of an intelligent terminal according to an exemplary embodiment of this Application;

FIG. 4 illustrates a block diagram of an exemplary embodiment of a terminal for performing the method according to this Application; and

FIG. 5 illustrates an exemplary embodiment of a storage unit for holding or carrying program codes to perform the method according to this Application.

### DETAILED DESCRIPTION OF THE INVENTION

The following detailed description is merely exemplary in nature and is not intended to limit the invention or the application and uses of the invention. Furthermore, there is no intention to be bound by any theory presented in the preceding background of the invention or the following detailed description.

Exemplary embodiments of this Application will be described below in further details with reference to the drawings. Although the exemplary embodiments of this Application are illustrated in the drawings, it shall be appreciated that this Application can be embodied in various forms but will not be limited to the embodiments described here. On the contrary these embodiments are provided so that this Application can become more apparent and the scope of this Application can be conveyed fully to those skilled in the art.

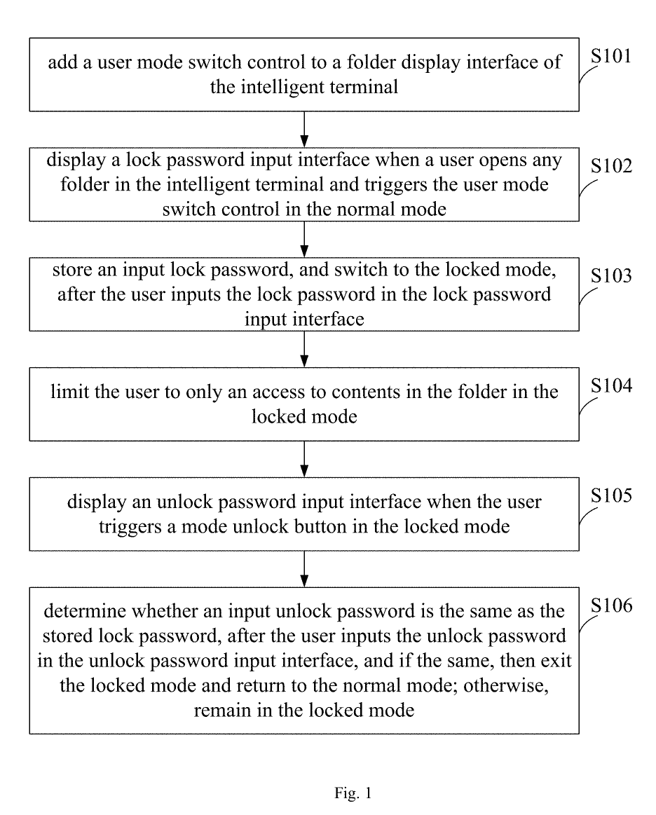

FIG. 1 illustrates a flow chart of a method for switching a user mode of an intelligent terminal according to an embodiment of this Application, where the user mode includes a normal mode and a locked mode, and the method includes the steps S101 to S106:

The step S101 is to add a user mode switch control to a folder display interface of the intelligent terminal.

In this step, after the user mode switch control is added to the folder display interface of the intelligent terminal, a user opening any folder will see the user mode switch control on the current interface of the folder to thereby make it convenient for the user to operate on.

The step S102 is to display a lock password input interface when the user opens any folder in the intelligent terminal and triggers the user mode switch control in the normal mode.

The normal mode here is a normal state where the intelligent terminal is not limited in any respect.

The step S103 is to store an input lock password, and to switch to the locked mode, after the user inputs the lock password in the lock password input interface.

In this step, in order to enable the user to input the correct password, the user can input the password again, and if the same password is input twice, then it is determined that the user has input the correct password; otherwise, the user is alerted that the password is incorrect and needs to be input again.

The step S104 is to limit the user to only an access to contents in the folder in the locked mode.

In this step, in the locked mode, the user can only start and run APPs in the folder but can not return to an upper directory and a homepage, that is, the user can neither exit the current folder nor see any messages related to an application in another folder than the current folder.

The step S105 is to display an unlock password input interface when the user triggers a mode unlock button in the locked mode.

In the locked mode, the mode unlock button is arranged on the user interface for the user to release the locked mode.

The step S106 is to determine whether an input unlock password is the same as the stored lock password, after the user inputs the unlock password in the unlock password input interface, and if the same, to exit the locked mode and to return to the normal mode; otherwise, to remain in the locked mode.

With the technical solution illustrated in FIG. 1, the user can preset a file suitable for a child and a folder suitable for another person, and switch the intelligent terminal to the locked mode of the corresponding folder when the intelligent terminal needs to be lent to the child or the other person for use, so that the child or the other person can only operate on an application in the specified folder to thereby avoid an improper operation, or leak of private contents. And, with the technical solution of this Application, the user mode switch control can be arranged on the folder display interface of the intelligent terminal, so it will be simple in operation for the user to switch the mode with a good user experience.

In an embodiment of this Application, in the case that a password input casually by the user is not impressive to and may be forgotten later by the user, a preset password remaining period of time is added to the method illustrated in FIG. 1, and particularly after the user inputs the lock password in the lock password input interface in the step S103, the lock password input interface including the input lock password remains for the preset period of time (e.g., two seconds) to alert the user to the input lock password, and the step of storing the input lock password and switching to the locked mode is performed after the preset period of time.

In an embodiment of this Application, the method illustrated in FIG. 1 further includes: upon switch to the locked mode, commanding the Activity component in the Android system to add a display panel of the folder to the Window Manager of the Android system and specifying the type of the panel as TYPE_SYSTEM_ERROR when adding, so as to add the panel to the topmost of the current panel. TYPE_SYSTEM_ERROR has been described in the official Google SDK, where TYPE represents the Window type: internal system error windows appearing on top of everything they can, so the panel can be added to the topmost of the current panel.

In an embodiment of this Application, the limiting the user to only an access to the contents in the folder in the step S104 comprises shielding functional buttons of exiting the folder and returning to the system homepage (including hard buttons arranged on the intelligent terminal, and soft buttons on the screen) and shielding a notice message (e.g., a notice bar, which can slide down, on the top of an Android interface). Thus in the locked mode, there is only an access to an application in the current file, but none of an incoming call notice, a short message notice, and any notice pushed by another application in another folder than the current folder can be seen.

In an embodiment of this Application, the shielding the functional buttons of exiting the folder and returning to the system homepage comprises registering Intent.ACTION_CLOSE_SYSTEM_DIALOGS of the Android system to monitor the functional buttons of exiting the folder and returning to the system homepage, and maintaining the display panel of the folder on the topmost of the current panel to prevent a change to the panel, upon reception of a message. Concretely, after the event of registering the system, the message can be received when the user presses both the Home button and the Recent App button (or the Home button can be pressed for a long period of time for the same effect), and at this time the display panel of the folder can be put on the topmost of the current panel of the intelligent terminal to thereby prevent the locked panel from being exited.

In an embodiment of this Application, the shielding the notice message comprises adding a check logic to the onWindowFocusChanged function available from the Android system, and maintaining the display interface of the folder on the topmost of the current panel (that is, putting it again on the topmost if it is not) to prevent a change to the panel, upon detection of a change in focus of the window. Thus the notice bar will be drawn back automatically when there is a notice message in the locked mode.

In another embodiment of this Application, the limiting the user to only an access to the contents in the folder in the step S104 comprises disabling functional buttons of exiting the folder and returning to the system homepage other than the Power button, and shielding other notice messages than an incoming call notice. In this embodiment, the Power button in the functional buttons can be handled exceptionally so that the intelligent terminal can be powered on and off in the locked mode. The incoming call notice in notice messages can be handled exceptionally to thereby prevent a call from being missed by the user. The intelligent terminal can be powered on and off even in the locked mode so that when the user forgets the unlock password to release the locked mode, the locked mode can be released through powering off and powering on again the intelligent terminal.

In an embodiment of this Application, in the step S106, after the user inputs the unlock password in the unlock password input interface, such a step can be performed, without any confirmation button being pressed, that is determining whether the input unlock password is the same as the stored lock password, and if the same, then exiting the locked mode and returning to the normal mode; otherwise, maintaining the locked mode. Thus after the user inputs the correct unlock password, the intelligent terminal will be switched immediately to the normal mode without any further pressing of the confirmation button by the user, to thereby improve the user experience.

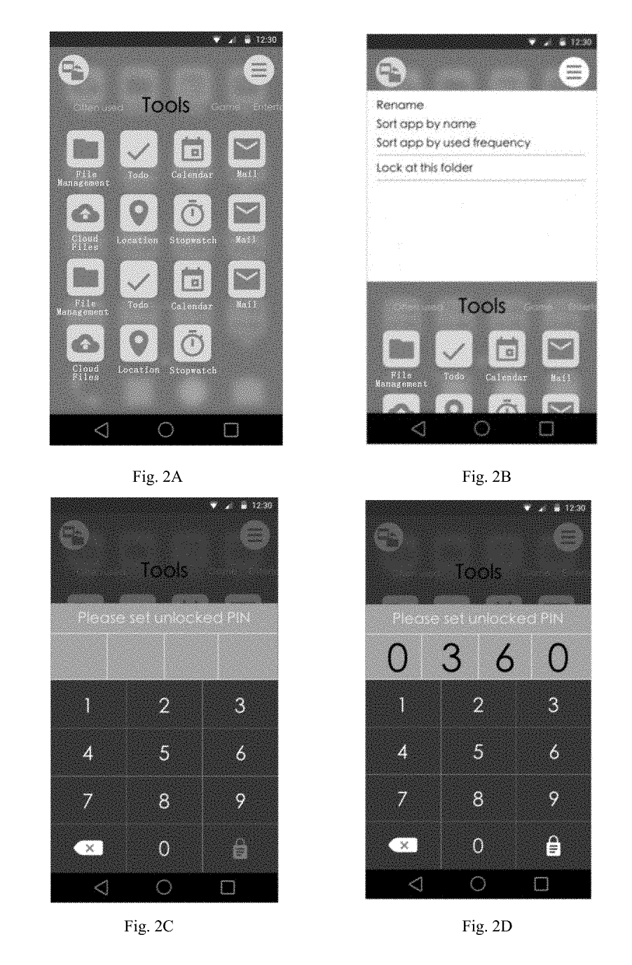

In order to make the technical solution of this Application more apparent, the following description will be given in the instance of user interfaces of a cell phone as illustrated in FIG. 2A to FIG. 2I.

FIG. 2A illustrates a schematic diagram of a folder display interface arranged with a user mode switch control according to an embodiment of this Application. As illustrated in FIG. 2A, the icon at the top-right corner of the interface is a button for triggering the user mode switch control.

FIG. 2B illustrates a schematic diagram when the user mode switch control illustrated in FIG. 2A is triggered according to an embodiment of this Application. As illustrated in FIG. 2B, a menu including an option “Lock at this folder” is popped out when the user mode switch control on the folder display interface is triggered.

FIG. 2C illustrates a schematic diagram of a lock password input interface according to an embodiment of this Application. The lock password input interface as illustrated in FIG. 2C is displayed when the option “Lock at this folder” illustrated in FIG. 2B is triggered.

FIG. 2D illustrates a schematic diagram of a password being input in the lock password input interface according to an embodiment of this Application. As illustrated in FIG. 2D, a four-digit password 0360 is input in this embodiment.

FIG. 2E illustrates a schematic diagram of remaining the interface on which the password is input according to an embodiment of this Application. As illustrated in FIG. 2E, the input password 0360 remains on the interface for a preset period of time, e.g., two seconds.

FIG. 2F illustrates a schematic diagram of an interface where the locked mode is entered according to an embodiment of this Application. As illustrated in FIG. 2F, the mode unlock button which is a “lock”-shaped icon on the upper part of FIG. 2F is arranged on the display interface of the current folder after entering the locked mode.

FIG. 2G illustrates a schematic diagram of an unlock password input interface according to an embodiment of this Application. As illustrated in FIG. 2G, the unlock password input interface is displayed when the mode unlock button in FIG. 2F is triggered.

FIG. 2H illustrates a schematic diagram of an unlock password being input in the unlock password input interface and a consequent success in unlocking according to an embodiment of this Application.

FIG. 2I illustrates a schematic diagram of entering the normal mode after the success in unlocking according to an embodiment of this Application.

With the solution above according to this Application, the user can set conveniently the intelligent terminal to a locked mode of a certain file so that there is only an access to an application in the folder in the locked mode. Thus the user can preset folders including different contents under different conditions (where the cell phone is lent to a child for playing, the cell phone is lent to another person for use, etc.), and when one of the conditions occurs, the user can simply choose to lock the corresponding folder so that the intelligent terminal can enter the locked mode in which there is only an access to an application in the folder. This solution can address the demand of the user, and it will be simple for the user to operate on with a good user experience.

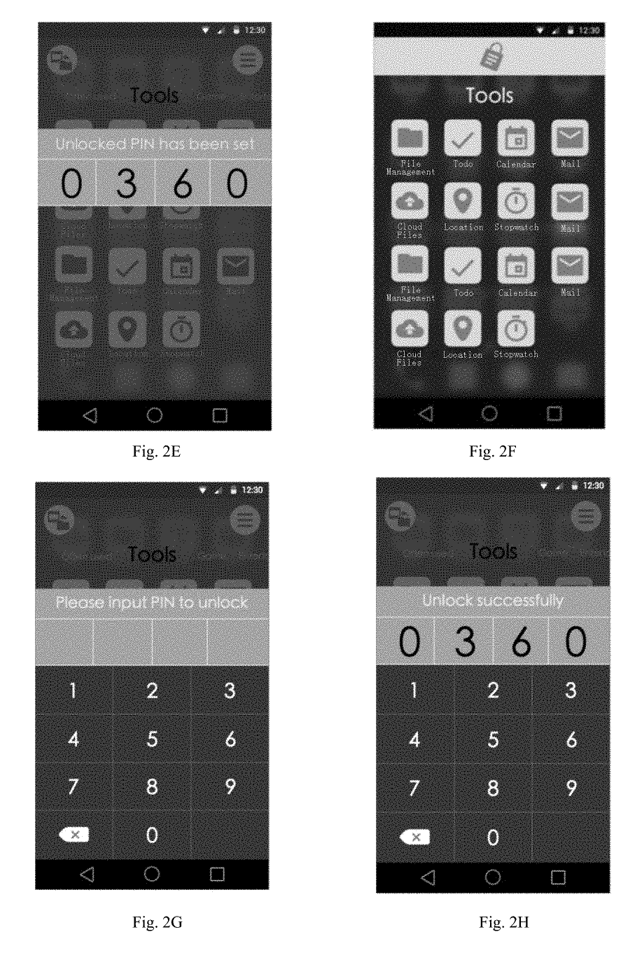

FIG. 3 illustrates a structural diagram of a device for switching a user mode of an intelligent terminal according to an embodiment of this Application, where the user mode includes a normal mode and a locked mode, and as illustrated in FIG. 3, the device 300 for switching a user mode of an intelligent terminal includes:

A control adding unit 310 is configured to add a user mode switch control to a folder display interface of the intelligent terminal. After the user mode switch control is added to the folder display interface of the intelligent terminal, a user opening any folder will see the user mode switch control on the current interface of the folder to thereby make it convenient for the user to operate.

A mode switch responding unit 320 is configured to display a lock password input interface when the user opens any folder in the intelligent terminal and triggers the user mode switch control in the normal mode; and to store an input lock password and to transmit an notification of switching to the locked mode to a locked mode unit, after the user inputs the lock password in the lock password input interface. The normal mode here is a normal state where the intelligent terminal is not limited in any respect.

The locked mode unit 330 is configured to limit the user to only an access to contents in the folder in the locked mode after reception of the notification of switching to the locked mode; and to release the limit after reception of an notification of exiting the locked mode. In the locked mode, the user can only start and execute APPs in the folder but can not return to an upper directory and a homepage, that is, the user can not exit the current folder.

The mode switch responding unit 320 is further configured to display an unlock password input interface when the user triggers a mode unlock button in the locked mode; and to determine whether an input unlock password is the same as the stored lock password, after the user inputs the unlock password in the unlock password input interface, and if the same, to transmit the notification of exiting the locked mode to the locked mode unit 330 so as to make the intelligent terminal return to the normal mode; otherwise, not to notify the locked mode unit.

With the functions of the device illustrated in FIG. 3, the user can preset a file suitable for a child and a folder suitable for another person, and switch the intelligent terminal to the locked mode of the corresponding folder when the intelligent terminal needs to be lent to the child or the other person for use, so that the child or the other person can only operate on an application in the specified folder to thereby avoid an improper operation, or leak of private contents; and with the technical solution of this Application, the user mode switch control can be arranged on the folder display interface of the intelligent terminal, so it will be simple in operation for the user to switch the mode with a good user experience.

In an embodiment of this Application, the mode switch responding unit 320 is further configured to control the lock password input interface including the input lock password to remain for a preset period of time to alert the user to the input lock password, after the user inputs the lock password in the lock password input interface; and to store the input lock password and to switch to the locked mode after the preset period of time. This can address effectively such a problem that a password input casually by the user is not impressive to and may be forgotten later by the user. The period of time for which the lock password input interface including the input lock password remains can be set as needed in reality, e.g., two seconds.

In an embodiment of this Application, the locked mode unit 330 is further configured, upon switch to the locked mode, command the Activity component in the Android system to add a display panel of the folder to the Window Manager of the Android system and to specify the type of the panel as TYPE_SYSTEM_ERROR when adding, so as to add the panel to the topmost of the current panel.

TYPE_SYSTEM_ERROR has been described in the official Google SDK, where TYPE represents the Window type: internal system error windows appearing on top of everything they can, so the panel can be added to the topmost of the current panel.

In an embodiment of this Application, the locked mode unit 330 is further configured to shield functional buttons of exiting the folder and returning to the system homepage, and to shield a notice message, after reception of the notification of switching to the locked mode. Thus, in the locked mode, there is only an access to an application in the current file, but none of an incoming call notice, a short message notice, and any notice pushed by another application in another folder than the current folder can be seen.

In an embodiment of this Application, the locked mode unit 330 is further configured to register Intent.ACTION_CLOSE_SYSTEM_DIALOGS of the Android system to monitor the functional buttons of exiting the folder and returning to the system homepage, and to maintain the display panel of the folder on the topmost of the current panel to prevent a change to the panel, upon reception of a message. Concretely after the event of registering the system, the message can be received when the user presses both the Home button and the Recent App button (or the Home button can be pressed for a long period of time for the same effect), and at this time the display panel of the folder (e.g., a folder dedicated to a child) can be put again on the topmost of the panel to thereby prevent the locked panel from being exited.

In an embodiment of this Application, the locked mode unit 330 is further configured to add a check logic to the onWindowFocusChanged function available from the Android system, and to maintain the display panel of the folder on the topmost of the current panel to prevent a change to the panel, upon detection of a change in focus of the window.

In another embodiment of this Application, the locked mode unit 330 is further configured to disable functional buttons of exiting the folder and returning to the system homepage other than the Power button, and to shield other notice messages than an incoming call notice, after reception of the notification of switching to the locked mode. In this embodiment, the Power button in the functional buttons can be handled exceptionally so that the intelligent terminal can be powered on and off in the locked mode. The incoming call notice in the notice messages can be handled exceptionally to thereby avoid a call from being missed by the user.

In an embodiment of this Application, the mode switch responding unit 320 is configured to, after the user inputs the unlock password in the unlock password input interface, perform the step, without any confirmation button being pressed, which is the determining whether the input unlock password is the same as the stored lock password, and if the same, exiting the locked mode and returning to the normal mode; otherwise, maintaining the locked mode. Thus, after the user inputs the correct unlock password, the intelligent terminal will be switched immediately to the normal mode without any further pressing of the confirmation button by the user, to thereby improve the user experience.

When the device 300 for switching a user mode of an intelligent terminal according to the embodiment of this Application is applied to an intelligent terminal, corresponding user interfaces thereof are as illustrated in FIG. 2A to FIG. 2I, so a repeated description thereof will be omitted here.

In an embodiment of this Application, there is further disclosed an intelligent terminal including the device for switching a user mode of an intelligent terminal according to any of the embodiments above of this Application. The intelligent terminal can be a cell phone or a PAD.

In summary. with the technical solution of this application, the user can preset a file suitable for a child and a number of folders suitable for other persons, and switch the intelligent terminal to the locked mode of the corresponding folder when the intelligent terminal needs to be lent to the child or the other person for use, so that the child or the other person can only operate on an application in the specified folder to thereby avoid an improper operation, or the leak of private contents; and with the technical solution of this Application, the user mode switch control can be arranged on the folder display interface of the intelligent terminal, so it will be simple in operation for the user to switch the mode with a good user experience.

It shall be noted that:

The algorithms and displays provided here will not be inherently relevant to any particular computer, virtual device or another device. Various general devices can also be used with the teaching based upon this Application here. Construction of structures required for these devices will be apparent from the description above. Moreover, this Application will not be directed to any particular programming language. It shall be appreciated that this Application of this Application described here can be put into practice in a variety of programming languages, and the description made above in terms of the particular language is merely for the purpose of disclosing the best modes of this Application.

Numerous particular details have been given in the description provided here. However, it shall be appreciated that the embodiments of this Application can be put into practice without these particular details. In some examples, well-known methods, structures and technologies have not been illustrated in details so as not to obscure understanding of the description.

Similarly, it shall be appreciated that in order to simplify this Application and facilitate understanding of one or more of the respective aspects of this Application, the respective features of this Application in the description above of the exemplary embodiments of this Application sometimes have been grouped together in a single embodiment or figure or a description thereof. However, the method disclosed here shall not be construed as reflecting such an intension that more than the features expressively recited in each claim will be required for this Application as claimed here. More precisely, less than all the features in the single embodiment disclosed earlier will be required in any aspect of this Application as reflected in the appended claims. Thus, the particular claim will be hereby incorporated expressively into the claims complying with the particular embodiments, where each of the claims itself is embodied as a separate embodiment of this Application.

Those skilled in the art can appreciate that the modules in the device according to the embodiment can be adapted and they can be arranged in one or more devices from the embodiment. The modules or units or components in the embodiment can be combined into a single module or unit or component, and moreover they each can be divided into a number of sub-modules or sub-units or sub-components. Unless at least some of these features and/or processes or elements are mutually exclusive, the respective features disclosed in the description (including the appended claims, the abstract and the drawing) and the respective processes or elements in any method or device disclosed as such can be combined in any combination. Unless stated otherwise, each of the features disclosed in the description (including the appended claims, the abstract and the drawing) can be replaced by an alternative feature for the same, equivalent or similar purpose.

Moreover, those skilled in the art can appreciate that although some embodiments described here include some features but not the other features, the features in the different embodiments can be combined into further different embodiments without departing from the scope of this Application. For example, any of the embodiments claimed in the appended claims can be applied in any combination.

The respective components in the embodiments of this Application can be embodied in hardware or in software modules run in one or more processors or in any combination of both. Those skilled in the art shall appreciate that some or all of the functions of some or all of the components in the device for switching a user mode of an intelligent terminal according to the embodiment of this Application can be performed in a microprocessor or a Digital Signal Processor (DSP) in practice. This Application can also be embodied as a device or apparatus program (e.g., a computer program and a computer program product) for performing a part or all of the method described here. Such a program in which this Application is embodied can be stored on a computer readable medium or can be embodied in the form of one or more signals. The signal or signals can be downloaded from a website on the Internet or can be available on a carrier signal or can be provided in any other form.

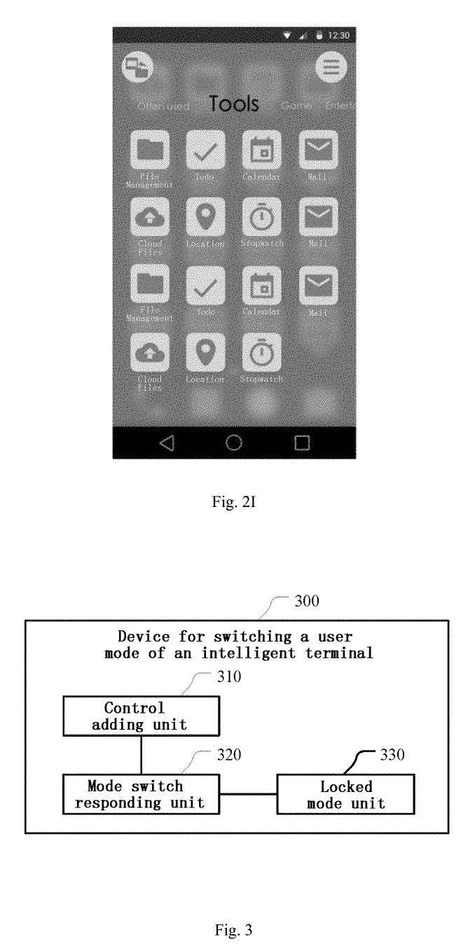

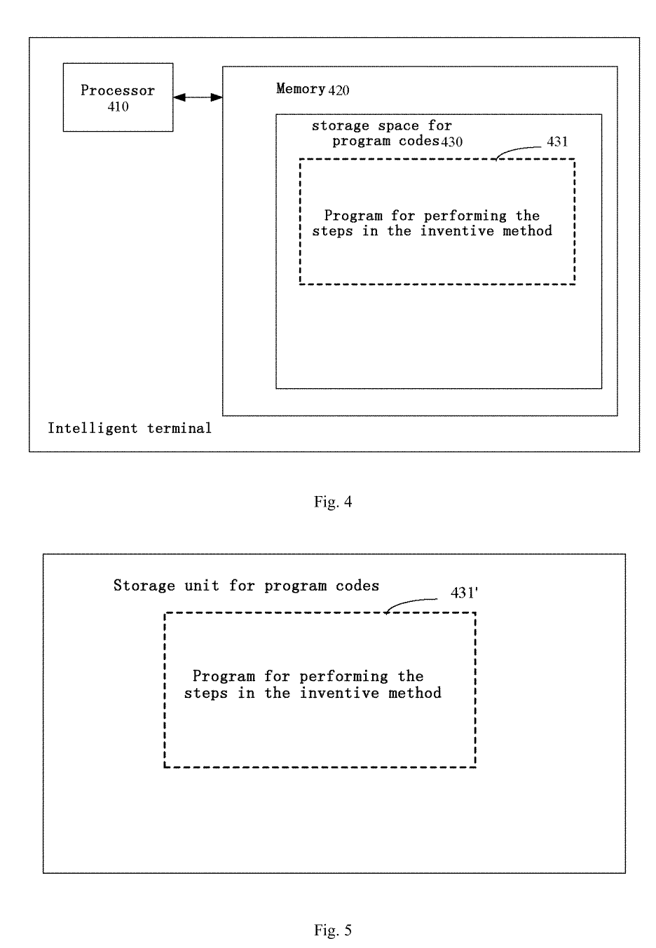

For example, FIG. 4 illustrates a terminal capable of switching a user mode according to this Application, e.g., an intelligent terminal. The terminal traditionally includes a processor 410, and a computer program product or a computer readable medium in the form of a memory 420. The memory 420 can be an electronic memory such as a flash memory, an Electrically Erasable Programmable Read Only Memory (EEPROM), an EPROM, a hard disk, an ROM. The memory 420 is provided with a storage space 430 including for program codes 431 to perform any of the steps in the method above. For example, the storage space 430 for the program codes can include respective program codes 431 for performing the respective steps in the method above respectively. These program codes can be read from or written into one or more computer program products including a program code carrier such as a hard disk, a Compact Disk (CD), a memory card, a floppy disk. The computer program product or products is or are typically a portable or fixed storage unit as illustrated in FIG. 5. The storage unit can be provided with storage segments, a storage space, etc., arranged similarly to the memory 420 in the terminal illustrated in FIG. 4. The program codes can be compressed in an appropriate form, for example. Typically, the storage unit includes computer readable codes 431′, i.e., codes which can be read by a processor, e.g., the processor 410, and upon being executed by the terminal, cause the terminal to perform the respective steps in the method described above.

“One embodiment”, “an embodiment” or “one or more embodiment” as referred to in this context means that a particular feature, structure or characteristic described in connection with the embodiment is included in at least one embodiment of this Application. Moreover, it shall be noted that the instances of the phrase “in one embodiment” may not necessarily all refer to the same embodiment.

Numerous particular details have been described in the description here. However, it shall be appreciated that the embodiments of the invention can be put into practice without these particular details. In some examples, well-known methods, structures and technologies have not been illustrated in details so as not to obscure understanding of the description.

It shall be noted that the embodiments above are merely for the purpose of illustrating the invention but not intended to limit the invention, and those skilled in the art can devise alternative embodiments without departing from the scope of the appended claims. Any reference numerals placed between parentheses in the claims shall not be construed as limiting the scope of this Application. The term “comprises/comprising” shall not preclude the presence of an element or a step which has not been listed in any claim. The term “a/an” preceding an element shall not preclude the presence of a plurality of such elements. This Application can be embodied in hardware including several different elements or in an appropriately programmed computer. In any claim in which several units of a device are listed, several of the units can be embodied particularly in the same item of hardware. The use of the terms “first”, “second”, “third”, etc., shall not suggest any particular order, but these terms can be interpreted as names.

Moreover, it shall be noted that the languages used in the description have been selected primarily for the purpose of intelligibility and teaching but not to define or limit the subject of matter of this Application. Accordingly, numerous modifications and variations will occur to those ordinarily skilled in the art without departing from the scope and spirit of the appended claims. This Application of this Application is illustrative of but not limiting the scope of this Application as defined in the appended claims.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for switching a user mode of an intelligent terminal, wherein the user mode comprises a normal mode and a locked mode, and the method comprises:
adding a user mode switch control to a folder display interface of the intelligent terminal;
displaying a lock password input interface when a user opens any folder in the intelligent terminal and triggers the user mode switch control in the normal mode;
storing an input lock password, and switching to the locked mode, after the user inputs the lock password in the lock password input interface;
limiting the user to only an access to contents in the folder in the locked mode;
displaying an unlock password input interface when the user triggers a mode unlock button in the locked mode; and
determining whether an input unlock password is the same as the stored lock password, after the user inputs the unlock password in the unlock password input interface, and if the same, then exiting the locked mode and returning to the normal mode; otherwise, remaining in the locked mode.

2. The method according to claim 1, wherein the method further comprises:
after the user inputs the lock password in the lock password input interface, remaining the lock password input interface comprising the input lock password for a preset period of time to alert the user to the input lock password, and performing the step of storing the input lock password and switching to the locked mode after the preset period of time.

3. The method according to claim 1, wherein the method further comprises:
upon switch to the locked mode, commanding the Activity component in the Android system to add a display panel of the folder to the Window Manager of the Android system, and specifying the type of the panel as TYPE_SYSTEM_ERROR when adding, so as to add the panel to the topmost of the current panel.

4. The method according to claim 1, wherein the limiting the user to only an access to the contents in the folder comprises:
shielding functional buttons of exiting the folder and returning to the system homepage, and
shielding a notice message.

5. The method according to claim 4, wherein the shielding the functional buttons of exiting the folder and returning to the system homepage comprises:
registering Intent.ACTION_CLOSE_SYSTEM_DIALOGS of the Android system to monitor the functional buttons of exiting the folder and returning to the system homepage; and
maintaining the display panel of the folder on the topmost of the current panel to prevent a change to the panel, upon reception of a message.

6. The method according to claim 4, wherein the shielding the notice message comprises:
adding a check logic to the onWindowFocusChanged function available from the Android system; and
maintaining the display panel of the folder on the topmost of the current panel to prevent a change to the panel, upon detection of a change in focus of the window.

7. The method according to claim 1, wherein the limiting the user to only an access to the contents in the folder comprises:
disabling functional buttons of exiting the folder and returning to the system homepage other than the Power button; and
shielding other notice messages than an incoming call notice.

8. The method according to claim 1, wherein after the user inputs the unlock password in the unlock password input interface, the step is performed, without any confirmation button being pressed, which is the determining whether the input unlock password is the same as the stored lock password, and if the same, then exiting the locked mode and returning to the normal mode; otherwise, maintaining in the locked mode.

9. A device for switching a user mode of an intelligent terminal, wherein the user mode comprises a normal mode and a locked mode, and the device comprises:
a control adding unit, configured to add a user mode switch control to a folder display interface of the intelligent terminal;
a mode switch responding unit, configured to display a lock password input interface when a user opens any folder in the intelligent terminal and triggers the user mode switch control in the normal mode; and to store an input lock password and to transmit an notification of switching to the locked mode to a locked mode unit, after the user inputs the lock password in the lock password input interface; and
the locked mode unit, configured to limit the user to only an access to contents in the folder in the locked mode after reception of the notification of switching to the locked mode; and to release the limit after reception of a notification of exiting the locked mode; and
the mode switch responding unit is further configured to display an unlock password input interface when the user triggers a mode unlock button in the locked mode; and to determine whether an input unlock password is the same as the stored lock password, after the user inputs the unlock password in the unlock password input interface, and if the same, to transmit the notification of exiting the locked mode to the locked mode unit so as to make the intelligent terminal return to the normal mode; otherwise, not to notify the locked mode unit.

10. The device according to claim 9, wherein
the mode switch responding unit is configured to control the lock password input interface comprising the input lock password to remain for a preset period of time to alert the user to the input lock password, after the user inputs the lock password in the lock password input interface, and to perform the step of storing the input lock password and switching to the locked mode after the preset period of time.

11. The device according to claim 9, wherein
the locked mode unit is further configured, upon switch to the locked mode, to command the Activity component in the Android system to add a display panel of the folder to the Window Manager of the Android system and to specify the type of the panel as TYPE_SYSTEM_ERROR when adding, so as to add the panel to the topmost of the current panel.

12. The device according to claim 9, wherein
the locked mode unit is further configured to shield functional buttons of exiting the folder and returning to the system homepage, and to shield a notice message, after reception of the notification of switching to the locked mode.

13. The device according to claim 12, wherein
the locked mode unit is further configured to register Intent.ACTION_CLOSE_SYSTEM_DIALOGS of the Android system to monitor the functional buttons of exiting the folder and returning to the system homepage, and to maintain the display panel of the folder on the topmost of the current panel to prevent a change to the panel upon reception of a message.

14. The device according to claim 12, wherein
the locked mode unit is further configured to add a check logic to the onWindowFocusChanged function available from the Android system, and to maintain the display panel of the folder on the topmost of the current panel to prevent a change to the panel upon detection of a change in focus of the window.

15. The device according to claim 9, wherein
the locked mode unit is configured to disable functional buttons of exiting the folder and returning to the system homepage other than the Power button, and to shield other notice messages than an incoming call notice, after reception of the notification of switching to the locked mode.

16. The device according to claim 9, wherein
the mode switch responding unit is configured to, after the user inputs the unlock password in the unlock password input interface, perform the step, without any confirmation button being pressed, which is the determining whether the input unlock password is the same as the stored lock password, and if the same, exiting the locked mode and returning to the normal mode; otherwise, maintaining in the locked mode.

17. An intelligent terminal, comprising a device for switching a user mode of an intelligent terminal, wherein the user mode comprises a normal mode and a locked mode, and the device comprises:
a control adding unit, configured to add a user mode switch control to a folder display interface of the intelligent terminal;
a mode switch responding unit, configured to display a lock password input interface when a user opens any folder in the intelligent terminal and triggers the user mode switch control in the normal mode; and to store an input lock password and to transmit an notification of switching to the locked mode to a locked mode unit, after the user inputs the lock password in the lock password input interface; and
the locked mode unit, configured to limit the user to only an access to contents in the folder in the locked mode after reception of the notification of switching to the locked mode; and to release the limit after reception of an notification of exiting the locked mode; and
the mode switch responding unit is further configured to display an unlock password input interface when the user triggers a mode unlock button in the locked mode; and to determine whether an input unlock password is the same as the stored lock password, after the user inputs the unlock password in the unlock password input interface, and if the same, to transmit the notification of exiting the locked mode to the locked mode unit so as to make the intelligent terminal return to the normal mode; otherwise, not to notify the locked mode unit.

18. The intelligent terminal according to claim 17, wherein the intelligent terminal is a cell phone or a PDA.

19. (canceled)

20. (canceled)
